(19) United States
(12) Patent Application Publication
(10) Pub. No.: US 2013/0043840 A1
(43) Pub. Date: Feb. 21, 2013

(54) SYSTEMS AND METHODS FOR PERFORMING CELL BALANCING IN A VEHICLE USING CELL CAPACITIES

(71) Applicants: Zachary D. Bylsma, Rochester Hills, MI (US); Matthew A. Herrmann, Royal Oak, MI (US)

(72) Inventors: Zachary D. Bylsma, Rochester Hills, MI (US); Matthew A. Herrmann, Royal Oak, MI (US)

(73) Assignee: GM GLOBAL TECHNOLOGY OPERATIONS LLC, Detroit, MI (US)

(21) Appl. No.: 13/210,636

(22) Filed: Aug. 16, 2011

(51) Int. Cl. H02J 7/04

(52) U.S. Cl. 320/118

(57) ABSTRACT

Systems and methods to perform cell balancing on a vehicle battery pack. Cell balancing regulates which cells are discharged during use of the battery pack. Individual cell capacities may be used to determine for how long individual cells are discharged.

### BACKGROUND OF THE INVENTION

The present invention relates generally to performing cell balancing in a multi-cell battery of a vehicle, and more particularly to systems and methods for performing cell balancing using individual cell capacities.

Automotive technology is rapidly expanding in the area of finding alternatives to using gasoline as the primary source of energy in vehicle propulsion systems. Many of these advances utilize either a hybrid mechanical-electrical system that recaptures some of the mechanical energy from the combustion engine as stored electrical energy, or a fully-electric propulsion system, which eliminates the need for an internal combustion engine entirely. With these advancements, the storage and management of electrical energy in vehicles has become of particular importance.

State of charge (SOC) is a commonly-used measure of the amount of charge available in a battery relative to the battery's capacity. In automotive applications that use fully electric or hybrid-electric propulsion systems, SOC measurements provide a useful indication of the amount of energy available to propel the vehicle. Similar to the information provided by a fuel gauge, an SOC measurement can provide a driver of an electric vehicle with an indication of how long the vehicle may travel before running out of energy.

The actual capacity of the battery is another important metric that denotes the overall amount of charge that can be stored in the battery. Typically, a battery is rated for capacity at its time of manufacture. However, as a battery ages, its capacity also decreases. In automotive applications, determination of the battery's actual capacity becomes extremely important because of its effect on SOC measurements. Where a battery's SOC measurement is somewhat analogous to how “full” a conventional fuel tank is in relation to its total volume (e.g., its capacity), batteries differ from conventional fuel tanks because their total capacities decrease over time. For example, a vehicle battery may only have 80% of its original capacity as it ages. Therefore, the actual capacity of a battery may be used to evaluate the overall condition and performance of the battery, in addition to adjusting its SOC estimations.

When the individual cells within the battery are connected in series, cell balancing provides a useful technique to optimize the capacity of the battery pack. In a battery having multiple cells, the capacity of the entire pack is dependent upon the cell having the lowest capacity. If the cells of the pack are unbalanced, two potential problems may occur. First, when the battery is being charged, cells run the risk of being overcharged, since some cells will reach their full capacity before other cells have been fully charged. Second, when the battery is discharged, cells that have not been fully charged will become fully depleted before other cells. In both cases, cell life is reduced, leading to lower performance and a reduced lifespan of the battery pack. Present cell balancing techniques, however, fail to account for variations in the individual capacities of cells in a pack and may erroneously perform cell balancing on low capacity cells.

### SUMMARY OF THE PRESENT INVENTION

In one embodiment, a method for performing cell balancing on a vehicle battery pack having a plurality of cells is disclosed. The method includes calculating or receiving, by one or more processors, an average cell capacity for the plurality of cells within the pack. The method also includes determining the difference between the cell capacity of an individual cell and the average cell capacity. The method further includes using the difference to determine a discharge timer value for a balancing gate that regulates the flow of current from the individual cell and controlling the balancing gate to discharge the individual cell based on the determined discharge timer value.

In another embodiment, a controller for performing cell balancing on a vehicle battery pack having a plurality of cells is disclosed. The controller includes one or more processors and a memory coupled to the one or more processors. The memory stores executable instructions that, when executed by the one or more processors, cause the one or more processors to calculate or receive an average cell capacity for the plurality of cells and to determine the difference between the cell capacity of an individual cell and the average cell capacity. The instructions also cause the one or more processors to use the difference to determine a discharge timer value for a balancing gate that regulates the flow of current from the individual cell and to generate a control command that causes the balancing gate to discharge the individual cell for an amount of time corresponding to the determined discharge timer value.

In another embodiment, a system for performing cell balancing in a vehicle is disclosed. The system includes voltage sensors configured to measure the voltage of a battery pack and voltages of a plurality of cells within the pack. The system also includes current sensors configured to measure the currents into and out of the pack. The system further includes a processing circuit that has an interface that receives voltage data from the voltage sensors and current data from the current sensors, one or more processors, and a memory coupled to the one or more processors. The memory stores executable instructions that, when executed by the one or more processors, cause the one or more processors to calculate an average cell capacity for the plurality of cells using the voltage or current data and to calculate a cell capacity of an individual cell. The instructions also cause the one or more processors to determine the difference between the cell capacity of the individual cell and the average cell capacity and to use the difference to determine a discharge timer value for a balancing gate that regulates the flow of current from the individual cell. The instructions further cause the one or more processors to generate a control command that causes the balancing gate to discharge the individual cell for an amount of time corresponding to the determined discharge timer value.

### BRIEF DESCRIPTION OF THE DRAWINGS

The following detailed description of specific embodiments can be best understood when read in conjunction with the following drawings, where like structure is indicated with like reference numerals and in which:

FIG. 1 is a schematic illustration of a vehicle having a battery pack;

FIG. 2 is a detailed diagram of the vehicle of FIG. 1,

FIG. 3 is a detailed diagram of the battery pack shown in FIGS. 1-2,

FIG. 4 is a computerized method for performing cell balancing, and

FIG. 5 is a detailed schematic illustration of the battery control module of FIGS. 2-3.

The embodiments set forth in the drawings are illustrative in nature and are not intended to be limiting of the embodiments defined by the claims. Moreover, individual aspects of the drawings and the embodiments will be more fully apparent and understood in view of the detailed description that follows.

### DETAILED DESCRIPTION OF THE PREFERRED EMBODIMENTS

As stated above, present cell balancing techniques fail to account for variations in the capacities of individual cells in a pack. Capacity estimations at the cell level, according to an aspect of the present invention, allow for more information to be gained about the state of the battery. This information can be used to improve the performance of cell balancing techniques, since it accounts for variations in the capacities of individual cells.

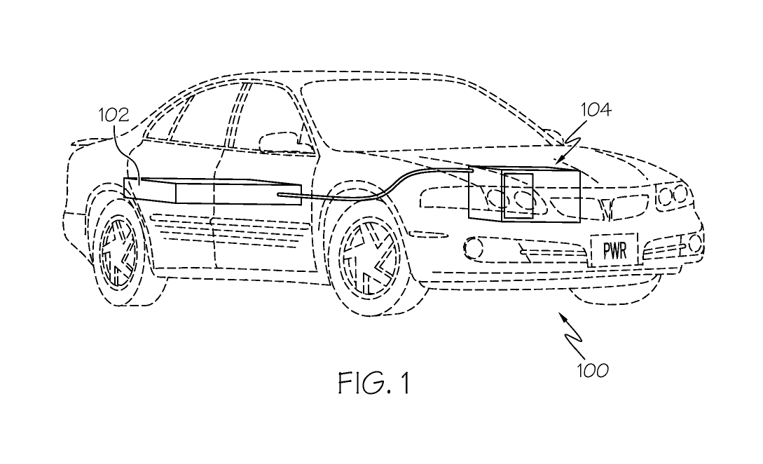

Referring now to FIG. 1, vehicle 100 is shown, according to an exemplary embodiment. Vehicle 100 includes battery pack 102 which provides electrical power to propel vehicle 100 using either a hybrid-electric or a fully-electric propulsion system. Battery pack 102 may include multiple battery cells, modules, or a collection of discrete batteries working in conjunction to provide propulsion power to vehicle 100 and/or to power electronics (e.g., audio electronics, navigational electronics, communication electronics, diagnostic electronics, and the like) in vehicle 100. Vehicle 100 also includes vehicle controller 104. Vehicle controller 104 is operatively connected to battery pack 102 and provides monitoring and control over the operation of battery pack 102. Vehicle controller 104 may also monitor or control one or more other functions of the vehicle. For example, vehicle controller 104 may provide information about the operational state of battery pack 102 to an electronic display within vehicle 100 to convey the information to the vehicle's driver. In other examples, vehicle controller 104 may also control the operations of the engine, the electrical system, or the exhaust system of vehicle 100.

Vehicle controller 104 may be a processing circuit that includes any number of hardware and software components. For example, vehicle controller 104 may include one or more processors in communication with one or more memory devices. The memory devices may store machine instructions that, when executed by the one or more processors, cause the one or more processors to implement some or all of the features described herein.

### Cell Balancing

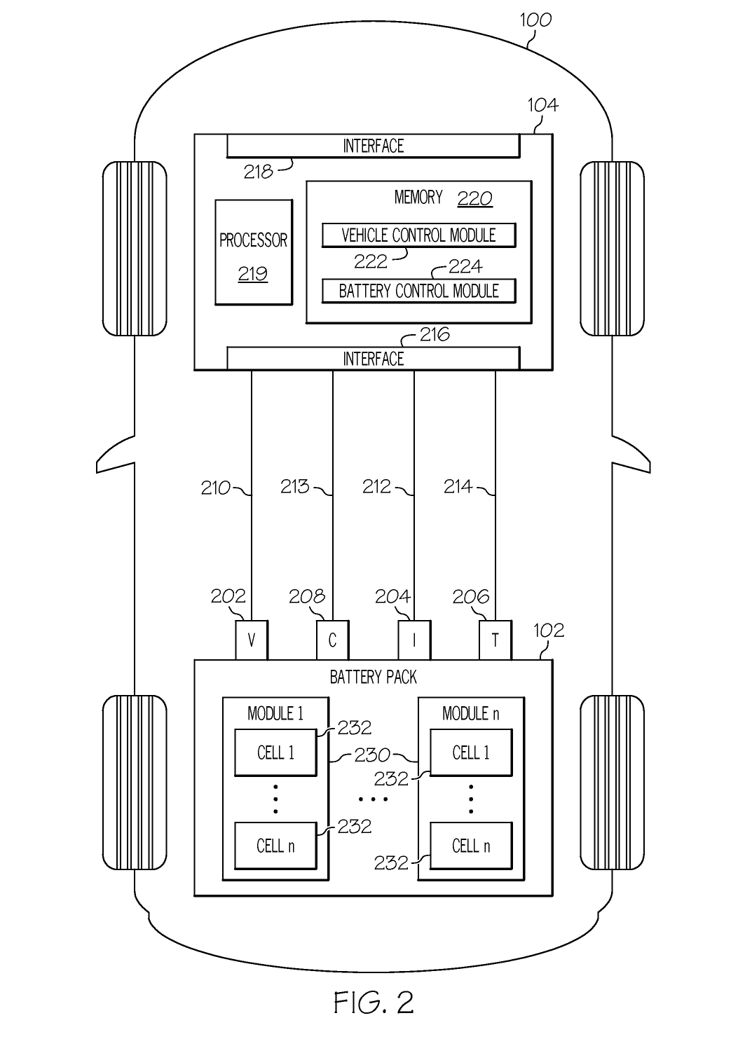

Referring now to FIG. 2, a detailed, schematic illustration of vehicle 100 is shown, according to an exemplary embodiment. Battery pack 102 includes modules 230, which provide cumulative electrical power to propel vehicle 100. Each of modules 230 contains a plurality of battery cells 232. Similarly, battery cells 232 are connected together to provide cumulative power at the module level of battery pack 102.

Vehicle 100 is also shown to include a number of sensors connected to battery pack 102. Voltage sensors 202 measure the voltage of battery pack 102, modules 230, and/or cells 232 and provides voltage values to interface 216 of controller 104 via bus line 210. Current sensors 204 measures the current of battery pack 102, modules 230, and/or cells 232 and provides current values to interface 216 of controller 104 via bus line 212. Temperature sensors 206 measures the temperature of battery pack 102, modules 230, and/or cells 232 and provides temperature values to interface 216 of controller 104 via bus line 214. Sensors 202, 204, and 206 may be any number of sensors or configurations to measure the voltages, currents, and temperatures associated with battery pack 102. For example, temperature sensor 206 may be a single temperature sensor, while voltage sensors 202 and current sensors 204 may be a combined integrated circuit that measures both voltages and currents. It should be appreciated that any number of different combinations of sensors and sensor configurations may be used, without deviating from the principles or teachings of the present disclosure.

In some embodiments, vehicle 100 may also include cell balancing controller 208, which performs cell balancing on battery pack 102 in response to receiving a control command from controller 104 via bus line 213. In other embodiments, cell balancing controller 208 is omitted and controller 104 may provide control commands directly to battery pack 102 via bus line 213, to perform cell balancing.

Bus lines 210, 212, 213, and 214 may be any combination of hardwired or wireless connections. For example, bus line 210 may be a hardwired connection to provide voltage readings to controller 104, while bus line 212 may be a wireless connection to provide current readings to controller 104. In some embodiments, bus lines 210, 212, 213, and 214 are part of a shared data line that conveys voltage, current, and temperature values to controller 104. In yet other embodiments, lines 210, 212, 213, and 214 may include one or more intermediary circuits (e.g., other microcontrollers, signal filters, etc.) and provide an indirect connection between sensors 202, 204, 206, cell balancing controller 208, and controller 104.

Interface 516 is configured to receive the sensor data from sensors 202, 204 and 206 via lines 210, 212, and 214. In addition, interface 516 may be configured to transmit and/or receive data between controller 104 and cell balancing controller 208. For example, interface 216 may include one or more wireless receivers, if any of lines 210, 212, 213, and 214 are wireless connections. Interface 216 may also include one or more wired ports, if any of lines 210, 212, 213, and 214 are wired connections. Interface 216 may also include circuitry configured to digitally sample or filter the sensor data from 202, 204 and 206. For example, interface 216 may sample the current data received from current sensors 204 via bus line 512 at discrete times (e.g., k, k+1, k+2, etc.) to produce discrete current values (e.g., I(k), I(k+1), I(k+2), etc.).

Controller 104 is also shown to include processor 219, which may be one or more processors (e.g., a microprocessor, an application specific integrated circuit (ASIC), field programmable gate array, or the like) communicatively coupled to memory 220 and interfaces 216 and 218. Memory 220 may be any form of memory capable of storing machine-executable instructions that implement one or more of the functions disclosed herein, when executed by processor 519. For example, memory 520 may be a RAM, ROM, flash memory, hard drive, EEPROM, CD-ROM, DVD, other forms of non-transitory memory devices, or any combination of different memory devices. In some embodiments, memory 220 includes vehicle control module 222, which provides control over one or more components of vehicle 100. For example, vehicle control module 222 may provide control over the engine of vehicle 100 or provide status condition information (e.g., vehicle 100 is low on fuel, vehicle 100 has an estimated number of miles left to travel based on the present SOC of battery pack 102, etc.) to one or more display devices in the interior of vehicle 100 via interface 218. In some embodiments, vehicle control module 222 may also communicate with other processing circuits (e.g., an engine control unit, an on-board diagnostics system, or the like) or other sensors (e.g., a mass airflow sensor, a crankshaft position sensor, or the like) via interface 218.

Interface 218 may provide one or more wired or wireless connections between processor 104 and the various systems of vehicle 100. For example, interface 518 may provide a wired connection between processor 104 and a dashboard display and a wireless connection between processor 104 and an on-board diagnostics system. In some embodiments, interface 218 may also provide a wireless connection between processor 104 and other computing systems external to vehicle 100. For example, processor 104 may communicate status condition information to an external server via a cellular, WiFi, radio, satellite connection, or the like. Interface 218 may also include one or more receivers configured to send and receive location information for vehicle 100. For example, interface 218 may include a GPS receiver or cellular receiver that utilizes triangulation to determine the location of vehicle 100. In other embodiments, interfaces 216 and 218 may be a shared interface.

Memory 220 is further shown to include battery control module 224, which is configured to monitor battery pack 102 and to control the cell balancing of battery pack 102. In some embodiments, battery control module 224 may also utilize sensor data from sensors 202, 204, and/or 206 to determine cell capacities for individual cells 232. Any number of different techniques may be used to determine the individual cell capacities. For example, systems and methods to calculate individual cell capacity values are disclosed in U.S. application Ser. No. 13/107,171, filed May 13, 2011, entitled “Systems and Methods for Determining Cell Capacity Values in a Multi-Cell Battery,” and assigned to the assignee of the present invention, the entirety of which is hereby incorporated by reference.

In another example, individual cell capacities may be calculated by controller 104 by performing a capacity test on battery pack 102. In such a test, each cell 232 is charged to full, or the high voltage limit (V_{lid}) of the cell, until the current is very small. This ensures that the cell voltage is at the desired value. Next, a cell 232 is discharge at a 1 C rate (e.g., if the cell capacity is 0.15625 Ahrs, then the cell would be discharged at 0.15625 A, or 156.25 mA) until the voltage reaches a minimum value (V_{floor}). The amount of Ampere-hours (Ahrs) moved through the cell from V_{lid} to V_{floor} would be the individual cell's capacity.

In yet another example, individual cell capacities may be calculated by controller 104 by performing a battery state estimation on each cell 232. In such a test, the SOC for each battery cell 232 is determined and then used to estimate the individual cell capacities. This technique is similar to the previous voltage-based method, but does not require a second, rested open-circuit voltage reading. In this test, a single open-circuit voltage is obtained (e.g., by voltage sensors 202) for an individual cell 232 and converted by controller 104 into an SOC estimation. Then, while vehicle 100 is being driven, the battery current (e.g., from current sensor 204) is also heavily filtered to see when it becomes very small, which occurs when the engine turns on. This is also known as charge sustaining. During driving, the Amperes per second are also stored by controller 104. If the average, filtered current remains small for a specified amount of time, the SOC is known to be stable and the difference between the rested and presently-reported SOC is used as the delta SOC. This is taken as a ratio with the Aperes per second moved through battery pack 102. The result can then be converted to Ahrs to get the capacity of each cell 232.

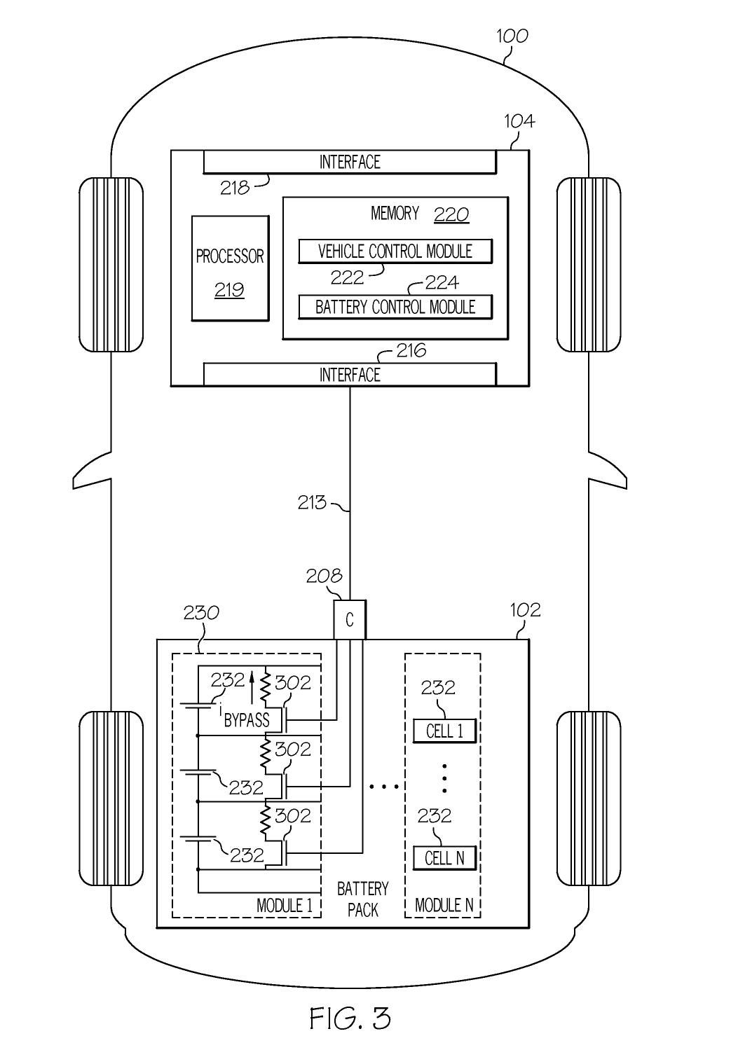

Referring now to FIG. 3, a detailed illustration of a battery pack 102 is shown, according to an exemplary embodiment. As shown, each module 230 includes a plurality of cells 232 arranged in series. Balancing gates 302 control the flow of current into and out of battery cells 232 by creating alternative paths for the flow of current. In this way, the charging and discharging of the individual battery cells 232 can be controlled, in order to balance cells 232. Any number of different circuit elements may be used for balancing gates 302 (e.g., transistors, logic gates, or the like). Although a particular circuit diagram is shown as part of battery pack 102, it is to be understood that this is merely exemplary and that any number of combinations of balancing gates 302 and battery cells 232 may be arranged to allow control over the charging and discharging of battery cells 232. For example, a single balancing gate 302 may control the charging and discharging of a plurality of cells 232 or an individual cell 232. In some embodiments, cell balancing controller 208 regulates the opening and closing of balancing gates 302, thereby controlling which of cells 232 are charged or discharged. For example, cell balancing controller 208 may receive a cell balancing command from controller 104 and open or close balancing gates 302, accordingly. In other embodiments, cell balancing controller 208 is part of controller 104, which provides direct control over the opening and closing of balancing gates 208.

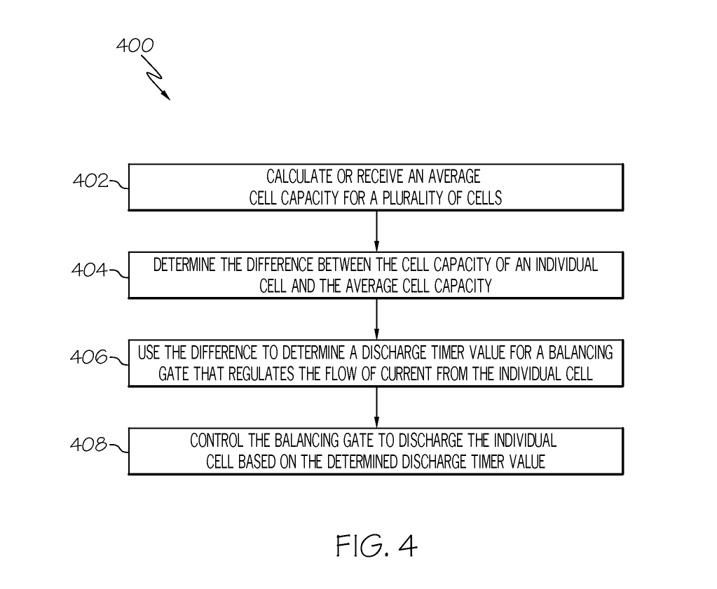

Referring now to FIG. 4, a computerized method for performing cell balancing is shown, according to an exemplary embodiment. Method 400 includes calculating or receiving an average cell capacity for a plurality of cells. In some embodiments, individual cell capacity values are determined by one or more processors (e.g., processor 219 or the like). Any number of techniques may be utilized to determine the individual cell capacities. In other embodiments, the one or more processors may receive the individual cell capacities from one or more other computing devices. In either case, individual cell capacities may be averaged by the one or more processors (e.g., using a simple average, weighted average, or the like), in order to determine the average cell capacity for the plurality of cells. In further embodiments, this determination is made by one or more other computing devices and provided to the one or more processors.

At step 404, the difference between the capacity of an individual cell and the average cell capacity is determined by the one or more processors. In this way, a relative distribution of cell capacities is built for the plurality of cells. The distribution allows identification of the cells in the plurality of cells that have the highest and lowest cell capacities. For example, the cells having the largest difference below the average capacity are the cells in the plurality that have the lowest capacities.

At step 406, the difference value is used by the one or more processors to determine a discharge timer value for a balancing gate that regulates the flow of current from the individual cell. Because cell performance degrades if a cell having a low capacity is overly discharged, the difference value determined in step 404 may be used to vary the amount time that an individual cell is charged or discharged. For example, the discharge timer value may correspond to an amount of time that a balancing gate 302 is held open or closed. In one embodiment, the discharge timer value (timer_{discharge}) may be determined using:

$${timer}_{discharge} = \frac{{capacity}_{i} - {capacity}_{avg}}{{I}_{bypass}} * Z$$

where capacity, is the individual cell capacity, capacity_{avg} is the average cell capacity for the cells to be balanced, I_{bypass} is the bypass current associated with the balancing gate, and Z is a conversion factor that converts a capacity into a count for the one or more processors that control the balancing gate. For example, I_{bypass} may be determined by measuring (e.g., via current sensors 208, or the like) the magnitude of current that flows across a balancing gate 302. Cell capacity is typically measured in Ampere-hours, meaning that dividing the capacity difference by the bypass current (measured in Amperes) results in a length of time. Since digital systems rely on clock cycles to measure an elapse of time, a conversion factor Z may be employed to convert the resulting length of time into a count for the one or more processors. The value of Z may be varied accordingly, depending on the clock cycle of the processor that controls the opening and closing of the balancing gate. In other embodiments, a raw measure of time is utilized as the discharge timer value, and is later converted into a count value by a processor directly controlling a balancing gate.

At step 408, the balancing gate is controlled to discharge the individual cell, based on the determined discharge timer value. The discharge timer value is used by the processor that controls the balancing gate to hold the gate open or closed for the amount of time specified by the discharge timer value, in order to discharge the individual cell. The power supplied by the discharged cell may be used, for example, to provide propulsion power to the vehicle and/or to power electronics of the vehicle. In this way, cells that have lower capacities are discharged for less time than cells having higher capacities.

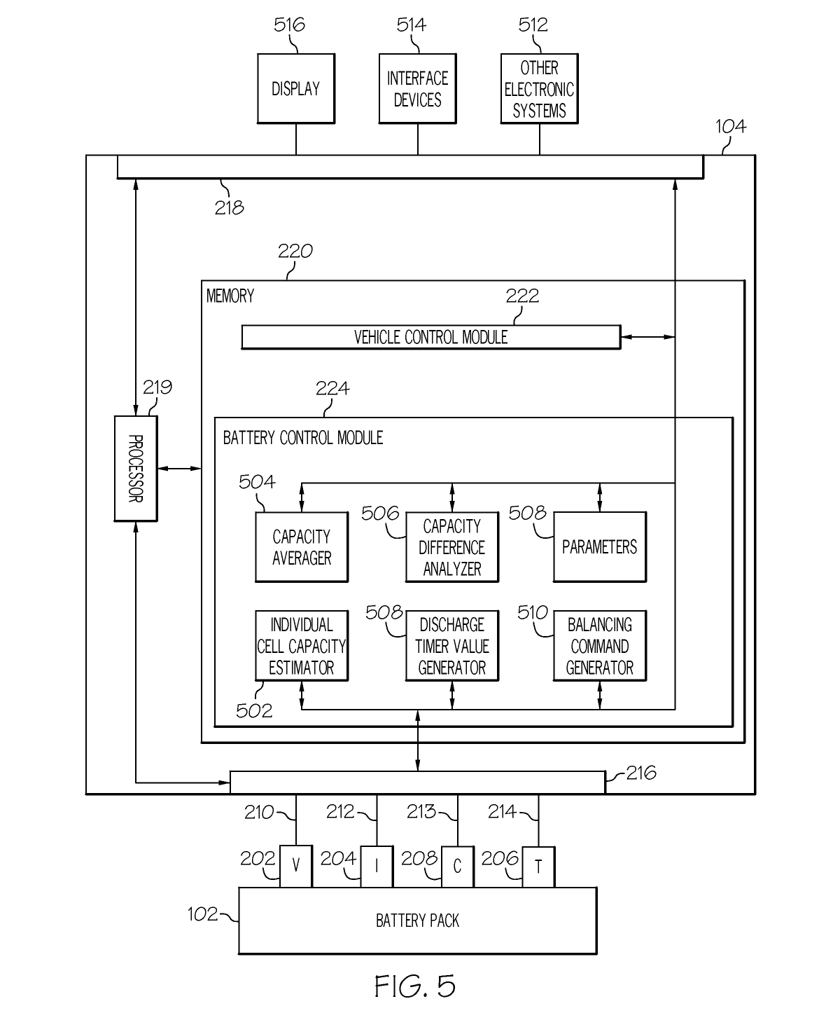

Referring now to FIG. 5, a detailed schematic illustration of controller 104 is shown, according to an exemplary embodiment. Controller 104 communicates with display 516, interface devices 514 (e.g., a keyboard, a touchscreen, a microphone, or any other device that allows a user to input information), and/or other electronic systems 512 (e.g., another controller, a server, a computer, a circuit, or any other electronic device) via interface 218. For example, vehicle control module 222 may provide control over the emissions system of vehicle 100, if other electronic systems 512 include electronics associated with such a system. In another example, controller 104 may provide visual indicia related to the operation of vehicle 100 to display 516.

Battery control module 224 may include parameters 508, which override or control the functions of battery control module 224. In some embodiments, some or all of parameters 508 may be preloaded into memory 220. In other embodiments, values in parameters 508 may be provided to controller 104 from interface devices 514 and/or other electronic systems 512.

In some embodiments, battery control module 224 includes individual cell capacity estimator 502. Individual cell capacity estimator 502 receives sensor data from sensors 202, 204, and/or 206 and uses the sensor data to determine the cell capacities for a plurality of individual cells in battery pack 102. Individual cell capacity estimator 502 may utilize any number of techniques to estimate the individual cell capacities, as previously discussed. In other embodiments, individual cell capacity estimator 502 is omitted and the individual cell capacities are provided to controller 104 by other electronic systems 512 and/or interface devices 514.

Capacity averager 504 receives individual cell capacities for a plurality of cells (e.g., from individual cell capacity estimator 502, parameters 508, other electronic systems 512, interface devices 514, or another source) and uses the received capacities to compute an average capacity for the plurality of cells. In some embodiments, capacity averager 504 may determine the average capacity (capacity_{avg}) as a simple average using:

$${capacity}_{avg} = \frac{{\sum }_{i = 1}^{n} {capacity}_{i}}{n}$$

where n is the number of cells to be balanced and capacity, is the capacity of the ith cell. In other embodiments, a weighting factor stored in parameters 508 may be applied to the individual cell capacities to determine the average capacity. Capacity averager 504 may also provide the average cell capacity to display 516, interface devices 514, and/or other electronic systems 512, for further evaluation.

Discharge timer value generator 508 receives the average cell capacity (e.g., from capacity averager 504 or another source) and the individual cell capacities (e.g., from individual cell capacity estimator 502 or another source) and uses these values to generate discharge timer values for the individual cells. A discharge timer value denotes the amount of time that an individual cell is to be discharged. For example, the discharge timer value may be a cycle count for a processor, a raw measure of time, or any other value that may be used to denote how long an individual cell is to be discharged. In some embodiments, the discharge timer value (timer_{discharge}) may be calculated as:

$${timer}_{discharge} = \frac{{capacity}_{i} - {capacity}_{avg}}{{I}_{bypass}} * Z$$

where capacity, is the individual cell capacity, capacity_{avg} is the average cell capacity for the cells to be balanced, I_{bypass} is the bypass current associated with the balancing gate (e.g., measured by current sensors 204), and Z is a conversion factor that converts a capacity into a count for the one or more processors that control the balancing gate.

In some embodiments, discharge timer value generator 508 may also provide the generated value to display 516, interface devices 514, and/or other electronic systems 512 via interface 218, for further evaluation. For example, a technician utilizing a handheld device or other device (e.g., other electronic systems 512) may view the discharge timer values to determine which cells are underperforming and/or require maintenance. Similarly, the discharge timer values may be provided to a remote server (e.g., other electronic systems 512), to allow the manufacturer of vehicle 100 to assess the performance of battery pack 102.

In further embodiments, discharge timer value generator 508 may also store a history of discharge timer values in memory 220. A historical timer value may be used, for example, if the most recent cell capacity estimate for an individual cell is unavailable. In another example, the history may be used to generate a report for diagnostic purposes.

Controller 104 may also include balancing command generator 510. Balancing command generator 510 determines when cell balancing is needed for battery pack 102 and generates a control command that causes the balancing gate associated with a cell to discharge the cell for the amount of time defined by the discharge timer value. Balancing command generator 510 may use the operational state of battery pack 102 (e.g., charging, discharging, at rest, or the like), to determine that cell balancing is to be performed. For example, balancing command generator 510 may determine that energy is needed to power electronics in the vehicle and/or to propel the vehicle. In response to this determination, balancing command generator 510 may provide a control command to balance the cells as they provide the needed power.

In some embodiments, cell balancing controller 208 regulates the actual opening and closing of a balancing gate. In this case, balancing command generator 510 may provide a control command to cell balancing controller 208 that causes it to operate a balancing gate. For example, the control command may include an indication that cell balancing is to be performed, when the cell balancing is to begin, and/or for how long the gate is to be operated (e.g., using the discharge timer value).

In other embodiments, cell balancing controller 208 is omitted and balancing command generator 510 provides direct control over one or more balancing gates. In this case, the control command may be a voltage or other signal that causes a balancing gate to open or close. Balancing command generator 510 may, for example, determine that cell balancing of battery pack 102 is needed, determine when the cell balancing is to begin, and/or provide the control signal to the balancing gate for the amount of time indicated by the discharge timer value.

Many modifications and variations of embodiments of the present invention are possible in light of the above description. The above-described embodiments of the various systems and methods may be used alone or in any combination thereof without departing from the scope of the invention. Although the description and figures may show a specific ordering of steps, it is to be understood that different orderings of the steps are also contemplated in the present disclosure. Likewise, one or more steps may be performed concurrently or partially concurrently.

What is claimed is:

1. A method for performing cell balancing on a vehicle battery pack having a plurality of cells comprising:
calculating or receiving, by one or more processors, an average cell capacity for the plurality of cells;
determining the difference between the cell capacity of an individual cell and the average cell capacity;
using the difference to determine a discharge timer value for a balancing gate that regulates the flow of current from the individual cell; and
controlling the balancing gate to discharge the individual cell based on the determined discharge timer value.

2. The method of claim 1, wherein the discharge timer value is determined using:
$${timer}_{discharge} = \frac{{capacity}_{i} - {capacity}_{avg}}{{I}_{bypass}} * Z$$
where capacity, is the individual cell capacity, capacity_{avg} is the average cell capacity for the pack, I_{bypass} is the bypass current associated with the balancing gate, and Z is a conversion factor that converts a capacity into a count for the processor.

3. The method of claim 1, further comprising providing the discharge timer value to a display.

4. The method of claim 1, further comprising using the discharged energy from the cell to propel the vehicle.

5. The method of claim 1, further comprising using the discharged energy to power electronics in the vehicle.

6. The method of claim 1, further comprising:
storing, in a memory, a history of discharge timer values.

7. A controller for performing cell balancing on a vehicle battery pack having a plurality of cells, said controller comprising:
one or more processors, and
a memory coupled to the one or more processors, wherein the memory
stores executable instructions that, when executed by the one or more
processors, cause the one or more processors to:
calculate or receive an average cell capacity for the plurality of cells;
determine the difference between the cell capacity of an individual cell and the average cell capacity;
use the difference to determine a discharge timer value for a balancing gate that regulates the flow of current from the individual cell; and
generate a control command that causes the balancing gate to discharge the individual cell for an amount of time corresponding to the determined discharge timer value.

8. The controller of claim 7, wherein the discharge timer value is determined using:
$${timer}_{discharge} = \frac{{capacity}_{i} - {capacity}_{avg}}{{I}_{bypass}} * Z$$
where capacity, is the individual cell capacity, capacity_{avg} is the average cell capacity for the pack, I_{bypass} is the bypass current associated with the balancing gate, and Z is a conversion factor that converts a capacity into a count for the one or more processors.

9. The controller of claim 7, wherein the instructions further cause the one or more processors to provide the discharge timer value to a display.

10. The controller of claim 7, wherein the instructions further cause the one or more processors to determine that energy is needed to propel the vehicle and to generate the control command in response to a determination that energy is needed to propel the vehicle.

11. The controller of claim 7, wherein the instructions further cause the one or more processors to determine that energy is needed to power electronics in the vehicle and to generate the control command in response to a determination that energy is needed to power electronics in the vehicle.

12. The controller of claim 7, wherein the instructions further cause the one or more processors to store a history of discharge timer values in the memory.

13. The controller of claim 12, wherein the instructions further cause the one or more processors to provide the history of discharge timer values to an electronic device located outside of the vehicle.

14. The controller of claim 13, wherein the electronic device is a handheld device.

15. A system for performing cell balancing in a vehicle comprising:
voltage sensors configured to measure the voltage of a battery pack and a plurality of cells within said pack;
current sensors configured to measure the currents into and out of the pack; and
a processing circuit comprising:
an interface that receives voltage data from the voltage sensors and current data from the current sensors;
one or more processors; and
a memory coupled to the one or more processors, wherein the memory stores executable instructions that, when executed by the one or more processors, cause the one or more processors to:
calculate an average cell capacity for the plurality of cells using the voltage or current data;
calculate a cell capacity of an individual cell;
determine the difference between the cell capacity of the individual cell and the average cell capacity;
use the difference to determine a discharge timer value for a balancing gate that regulates the flow of current from the individual cell; and
generate a control command that causes the balancing gate to discharge the individual cell for an amount of time corresponding to the determined discharge timer value.

16. The system of claim 15, wherein the discharge timer value is determined using:
$${timer}_{discharge} = \frac{{capacity}_{i} - {capacity}_{avg}}{{I}_{bypass}} * Z$$
where capacity, is the individual cell capacity, capacity_{avg} is the average cell capacity for the pack, I_{bypass} is the bypass current associated with the balancing gate, and Z is a conversion factor that converts a capacity into a count for the one or more processors.

17. The system of claim 15 further comprising a cell balancing controller that provides control over the opening and closing of the balancing gate, wherein processing circuit provides the control command to the cell balancing controller, and wherein the cell balancing controller opens or closes the balancing gate in response to receiving the control command.

18. The system of claim 15, wherein the control command comprises a voltage that opens or closes the balancing gate.

19. The system of claim 15, wherein the instructions further cause the one or more processors to store a history of discharge timer values in the memory.

20. The system of claim 19, wherein the instructions further cause the one or more processors to provide the history of discharge timer values to an electronic device located outside of the vehicle.
